(19) United States
(12) Patent Application Publication
(10) Pub. No.: US 2026/0070846 A1
(43) Pub. Date: Mar. 12, 2026

(54) GREEN GYPSUM BOARD PREPARED USING LOW WATER TO SOLIDS RATIO

(71) Applicant: UNITED STATES GYPSUM COMPANY, Chicago, IL (US)

(72) Inventors: Yijun SANG, Oak Park, IL (US); Mark Kenneth HEMPHILL, Hawthorn Woods, IL (US); Annamaria VILINSKA, Chicago, IL (US); George VLADIMIROV, Des Plaines, IL (US)

(73) Assignee: UNITED STATES GYPSUM COMPANY, Chicago, IL (US)

(21) Appl. No.: 19/221,992

(22) Filed: May 29, 2025

Related U.S. Application Data
(60) Provisional application No. 63/685,594, filed on Aug. 21, 2024.

(51) Int. Cl. C04B 28/14; B28B 3/00; C04B 38/08; C04B 40/00; C04B 40/02; C04B 111/00

(52) U.S. Cl. CPC C04B 28/14; B28B 3/00; C04B 38/08; C04B 40/0032; C04B 40/0263; C04B 2111/0062

(57) ABSTRACT

Disclosed are gypsum boards and methods of board preparation. The board comprises a set gypsum core, with a cover sheet disposed on either side of the core. The core is formed from a mixture containing water, stucco, uncalcined gypsum, and optional additives, the mixture having a low water-to-solids ratio. A hydration reaction occurs between water and stucco. The water amount can be, e.g., 0% to 30%, such as 1% to 25% or 1% to 20%, higher than the stoichiometric amount for hydration. For board preparation, an industrial press (e.g., hydraulic or pneumatic) or rollers can be used to form designated board thickness. Green technology is deployed since less energy is consumed to calcine the gypsum into stucco (inasmuch as some solids content need not be calcined because of the uncalcined gypsum content in the mixture) and for board drying. Improved production efficiencies and high-quality product with strength are achieved.

### CROSS-REFERENCE TO RELATED APPLICATIONS

This patent application claims the benefit of U.S. Provisional Patent Application No. 63/685,594, filed Aug. 21, 2024, which is incorporated by reference.

### BACKGROUND

Set gypsum is a well-known material that is used in many products, including panels and other products for building construction and remodeling. One such panel (often referred to as gypsum board) is in the form of a set gypsum core sandwiched between two cover sheets (e.g., paper-faced board) and is commonly used in drywall construction of interior walls and ceilings of buildings. One or more dense layers, often referred to as “skim coats” may be included on either side of the core, usually at the paper-core interface.

Gypsum (calcium sulfate dihydrate) is naturally occurring and can be mined in rock form. It can also be in synthetic form (referred to as “syngyp” in the art) as a by-product of industrial processes such as flue gas desulfurization. From either source (natural or synthetic), gypsum can be calcined at high temperature to form stucco (i.e., calcined gypsum primarily in the form of calcium sulfate hemihydrate) and then rehydrated to form set gypsum in a desired shape (e.g., as a board). During manufacture of the board, the stucco, water, and other ingredients as appropriate are mixed, typically in a wallboard slurry mixer as the term is used in the art. A slurry is formed and discharged from the mixer onto a moving conveyor carrying a cover sheet with one of the skim coats (if present) already applied (often upstream of the mixer). The slurry is spread over the paper (with skim coat optionally included on the paper). Another cover sheet, with or without skim coat, is applied onto the slurry to form the sandwich structure of desired thickness with the aid of, e.g., a forming plate or the like. The mixture is cast and allowed to harden to form set (i.e., rehydrated) gypsum by reaction of the calcined gypsum with water to form a matrix of crystalline hydrated gypsum (i.e., calcium sulfate dihydrate). It is the desired hydration of the calcined gypsum that enables the formation of the interlocking matrix of set gypsum crystals, thereby imparting strength to the gypsum structure in the product. The calcined gypsum reacts with the water in the wallboard preform and sets as a conveyor moves the wallboard preform down a manufacturing line. The wallboard preform is cut into segments at a point along the line where the preform has set sufficiently. Heat is typically used (e.g., in a kiln) to drive off the remaining free (i.e., unreacted) water to yield a dry product.

Prior devices and methods for addressing some of the operational problems associated with the production of gypsum wallboard are disclosed in commonly-assigned U.S. Pat. Nos. 5,683,635; 5,643,510; 6,494,609; 6,874,930; 7,007,914; and 7,296,919, which are incorporated by reference. There is a continued need in the art to provide additional solutions to enhance the production of cementitious boards.

It will be appreciated that this background description has been created by the inventors to aid the reader, and is not to be taken as a reference to prior art nor as an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of any embodiments of the disclosure to solve any specific problem noted herein.

### BRIEF SUMMARY

The present disclosure is premised, at least in part, on the preparation of gypsum board using a mixture containing water, stucco, gypsum (also referred to as uncalcined gypsum), and optional wet and/or dry additives. The mixture can be in the form of a moistened solid having a low water to solids ratio while using substantially no or low excess water relative to the stoichiometric amount (e.g., 0% to 30%, such as 0% to 25% or 0% to 20%) higher than the stoichiometric amount for the hydration reaction of stucco to form gypsum in the shape of board). Foaming agent can be excluded. To reduce density, as desired, lightweight filler can be included in the mixture. The board can be prepared in any suitable manner, e.g., in a mold using an industrial press (such as a hydraulic or pneumatic press).

Thus, in one aspect, the present disclosure provides a gypsum board. The board comprises a set gypsum core formed from a mixture comprising water, stucco, and gypsum. The mixture has a weight ratio of stucco to gypsum of from 9:1 to 40:1 (such as from 9:1 to 20:1, e.g., from 15:1 to 20:1, etc.) (e.g., when pregelatinized starch is excluded) and the mixture has a water/solids ratio of 0.3 or less (such as from 0.19 to 0.3, e.g., from 0.19 to 0.25, or 0.19 to 0.22, e.g., from 0.2 to 0.3, from 0.2 to 0.25, from 0.2 to 0.23, from 0.25 to 0.3, etc.). The term “solids” in terms of the water/solids ratio as used herein refers to the sum of stucco and uncalcined gypsum unless otherwise indicated.

In another aspect, the present disclosure provides a gypsum board comprising a set gypsum core formed from a mixture comprising water, stucco, gypsum, and pregelatinized starch. The mixture for forming the set gypsum core has a weight ratio of stucco to gypsum of from 1:1 to 40:1 (such as from 2.5:1 to 40:1, e.g., from 5:1 to 30:1, 10:1 to 25:1, etc.) and a water/solids ratio of 0.3 or less or 0.25 or less (such as from 0.19 to 0.3, e.g., from 0.19 to 0.25).

In another aspect, the present disclosure provides a method of making gypsum board comprising a set gypsum core. The method comprises mixing ingredients comprising water, stucco, and gypsum to form a mixture for forming the set gypsum core. The mixture for forming the set gypsum core has a weight ratio of stucco to gypsum of from 9:1 to 40:1 (such as from 10:1 to 40:1, e.g., from 15:1 to 40:1) (e.g., when pregelatinized starch is excluded) and the mixture for forming the set gypsum core has a water/solids ratio of 0.3 or less (such as from 0.19 to 0.3, e.g., from 0.19 to 0.3, or 0.19 to 0.25, e.g., from 0.2 to 0.3, from 0.2 to 0.25, from 0.2 to 0.23, from 0.25 to 0.3, etc.). The method includes pressing the mixture. The board can be allowed to dry at room temperature or using a drying apparatus equipped with heating element(s). The pressing can occur through the use of, for example, rollers or a machine press. In embodiments using the machine press, the mixture can, e.g., be placed into a mold having dimensions corresponding to desired board dimensions with the pressure applied thereon using, for example, a pneumatic or hydraulic press.

In another aspect, the present disclosure provides a method of making gypsum board comprising a set gypsum core. The method comprises mixing ingredients comprising water, stucco, gypsum, and pregelatinized starch to form a mixture for forming the set gypsum core. The mixture has a weight ratio of stucco to gypsum of from 1:1 to 40:1 or 2.5:1 to 40:1 (such as from 5:1 to 40:1, e.g., from 20:1 to 40:1) and the mixture has a water/solids ratio of 0.3 or less (such as from 0.19 to 0.3, e.g., from 0.19 to 0.3, or 0.19 to 0.25, e.g., from 0.2 to 0.3, from 0.2 to 0.25, from 0.2 to 0.23, from 0.25 to 0.3, etc.). The method includes pressing the mixture. The board can be allowed to dry at room temperature or using a drying apparatus equipped with heating element(s). The pressing can occur through the use of, for example, rollers or a machine press. In embodiments using the machine press, the mixture can, e.g., be placed into a mold having dimensions corresponding to desired board dimensions with the pressure applied thereon using, for example, a pneumatic or hydraulic press.

In another aspect, the present disclosure provides a mixture comprising water, stucco, and gypsum. The mixture has a weight ratio of stucco to gypsum of from 9:1 to 40:1 (such as from 10:1 to 40:1, e.g., from 20:1 to 40:1 and as further described herein) (e.g., when pregelatinized starch is excluded) and the mixture has a water/solids ratio 0.3 or less (such as from 0.19 to 0.3, e.g., from 0.19 to 0.3, or 0.19 to 0.25, e.g., from 0.2 to 0.3, from 0.2 to 0.25, from 0.2 to 0.23, from 0.25 to 0.3, etc.). The mixture can be in the form of a moistened solid and can exclude foaming agent. The reduce density, lightweight filler can be included in the mixture. The lightweight filler can be in the form of porous glass beads or wood cork. The mixture can be used, for example, in the production of a set gypsum core in a gypsum board.

In another aspect, the present disclosure provides a mixture comprising water, stucco, gypsum, and pregelatinized starch. The mixture has a weight ratio of stucco to gypsum of from 1:1 to 40:1 (such as from 2:1 to 40:1, e.g., from 5:1 to 40:1 and as further described herein) and the mixture has a water/solids ratio of 0.3 or less (such as from 0.19 to 0.3, e.g., from 0.19 to 0.3, or 0.19 to 0.25, e.g., from 0.2 to 0.3, from 0.2 to 0.25, from 0.2 to 0.23, from 0.25 to 0.3, etc.). The mixture can be in the form of a moistened solid and can exclude foaming agent. The reduce density, lightweight filler can be included in the mixture. The lightweight filler can be in the form of porous glass beads or wood cork. The mixture can be used, for example, in the production of a set gypsum core in a gypsum board.

Further and alternative aspects and features of the disclosed principles will be appreciated from the following detailed description and the accompanying drawings. As will be appreciated, the slurries, boards, and methods disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWING(S)

FIG. 1A is a flow diagram of the process for preparing gypsum board from a mixture using a press according to embodiments of the present disclosure.

FIG. 1B is a flow diagram of the process for preparing gypsum board from a mixture using a press and a dryer according to embodiments of the present disclosure.

FIG. 1C is a flow diagram of the process for preparing gypsum board from a mixture containing pregelatinized starch using a press according to embodiments of the present disclosure.

FIG. 1D is a flow diagram of the process for preparing gypsum board from a mixture containing pregelatinized starch using a press and a dryer according to embodiments of the present disclosure.

FIG. 2A is a schematic illustration depicting the preparation of board using rollers according to embodiments of the present disclosure.

FIG. 2B is a schematic illustration depicting the preparation of board using press technology according to embodiments of the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

Embodiments of the disclosure provide a gypsum board and methods of making gypsum board. The gypsum boards comprise a board core containing set gypsum (referred to as the “set gypsum core” or “core”). A cover sheet can be used on one or both sides of the board, e.g., the core can be sandwiched between two cover sheets (i.e., face and back cover sheets). The set gypsum core is formed from a mixture containing water, stucco (calcined gypsum, generally in the form of calcium sulfate alpha hemihydrate or calcium sulfate beta hemihydrate), gypsum (calcium sulfate dihydrate), and, optionally, dry additives and/or wet additives. Any suitable ratio of stucco to gypsum can be used, e.g., from 1:1 to 40:1., such as from 1:1 to 30:1, from 1:1 to 20:1, from 1:1 to 10:1, from 1:1 to 8:1, from 1:1 to 5:1, from 1:1 to 2.5:1, from 2.5:1 to 40:1, from 2.5:1 to 30:1, from 2.5:1 to 20:1, from 2.5:1 to 10:1, from 2.5:1 to 8:1, from 2.5:1 to 5:1, from 4:1 to 40:1, from 4:1 to 30:1, from 4:1 to 20:1, from 4:1 to 10:1, from 4:1 to 8:1, from 5:1 to 40:1, from 5:1 to 30:1, from 5:1 to 25:1, from 5:1 to 20:1, from 5:1 to 10:1, 5:1 to 8:1, etc. In some embodiments, e.g., when pregelatinized starch is excluded, the ratio of stucco to gypsum can range relatively higher, e.g., from 9:1 to 40:1, such as from 9:1 to 30:1, from 9:1 to 25:1, from 9:1 to 20:1, from 9:1 to 15:1, from 12:1 to 40:1, from 12:1 to 30:1, from 12:1 to 25:1, from 12:1 to 20:1, from 12:1 to 15:1, from 15:1 to 40:1, from 15:1 to 35:1, from 15:1 to 30:1, from 15:1 to 20:1, from 20:1 to 40:1, from 20:1 to 30:1. Dry additives include, for example, pregelatinized starch, polyphosphate, and lightweight filler, such as porous glass beads and/or wood cork. Accelerator is surprisingly and unexpectedly unnecessary in some embodiments because the mixture for forming the set gypsum core is generally fast setting, although it can be included if desired. In some embodiments, accelerator (e.g., HRA) optionally can be included to enhance strength, e.g., when higher amounts of uncalcined gypsum are included relative to stucco in the mixture for forming the set gypsum core. In some embodiments, such as when pregelatinized starch is used, the ratio of stucco to gypsum can include relatively lower ranges, e.g., from 1:1 to 40:1, such as from 1:1 to 30:1, from 1:1 to 20:1, from 1:1 to 10:1, from 1:1 to 8:1, from 1:1 to 5:1, from 1:1 to 2.5:1, from 2.5:1 to 40:1, from 2.5:1 to 30:1, from 2.5:1 to 20:1, from 2.5:1 to 10:1, from 2.5:1 to 8:1, from 2.5:1 to 5:1, from 4:1 to 40:1, from 4:1 to 30:1, from 4:1 to 20:1, from 4:1 to 10:1, from 4:1 to 8:1, from 5:1 to 40:1, from 5:1 to 30:1, from 5:1 to 25:1, from 5:1 to 20:1, from 5:1 to 10:1, 5:1 to 8:1, etc., which thereby allows for the use of less stucco in the mixture relative to gypsum. Pregelatinized starch is also desirable to enhance strength, e.g., in the preparation of light weight wallboard in some embodiments. Uncooked starch is excluded as a strength enhancer in some embodiments, particularly where the board is prepared using a press or rollers operating at or near room temperature, e.g., from 17° C. to 35° C., or as further described herein. Wet additives include, for example, retarder. If desired, each wet and/or dry additive can be individually delivered to the mixer or mixed in various combinations (e.g., wet additives mixed together and dry additives mixed together and then delivered to the mixer). Surprisingly and unexpectedly, in embodiments of the disclosure, the board is prepared using a low water to solids ratio such that there is no or a low amount of excess water (e.g., below 30%, e.g., from 19% to 25%). In some embodiments, the water is in an amount slightly higher (e.g., 0-30% higher, e.g., 10% to 30% higher, 0% to 20% higher, or 10%-20% higher) than stoichiometric water for the hydration reaction for converting the hemihydrate form of calcium sulfate (stucco) to calcium sulfate dihydrate (gypsum), generally 19%. In some embodiments, the ratio of water to solids (made up of calcium sulfate hemihydrate and calcium sulfate dihydrate) is 0.3 or less on a weight basis (such as from 0.19 to 0.3, e.g., from 0.19 to 0.3, or 0.19 to 0.25, e.g., from 0.2 to 0.3, from 0.2 to 0.23, from 0.25 to 0.3, etc.). As such, the mixture for forming the set gypsum core can be in the form of a moistened powder as opposed to a slurry. The board can be prepared at any suitable density, e.g., 15 pcf to 85 pcf, such as from 20 pcf to 70 pcf, e.g., from 20 pcf to 60 pcf, from 20 pcf to 50 pcf, from 20 pcf to 40 pcf, from 20 pcf to 35 pcf, from 20 pcf to 30 pcf, from 30 pcf to 85 pcf, from 30 pcf to 70 pcf, from 30 pcf to 60 pcf, from 30 pcf to 50 pcf, from 30 pcf to 40 pcf, from 40 pcf to 85 pcf, from 40 pcf to 70 pcf, from 40 pcf to 60 pcf, from 40 pcf to 50, from 50 pcf to 85 pcf, from 50 pcf to 70 pcf, from 50 pcf to 60 pcf, from 60 pcf to 85 pcf, from 70 pcf to 85 pcf, etc. Surprisingly and unexpectedly, the board can be prepared without the use of foaming agent. In this regard, it has been found that air foam is more suitable for addition into a slurry as opposed to a moistened solid. The mixture for forming the set gypsum core used herein can be prepared into the form of a moistened powder with low water to solids ratio, and not a slurry having higher water to solids ratio. Instead of foaming agent, the board can be prepared using a lightweight filler as described herein. In some embodiments, the board can be prepared without a skim coat between the core and the cover sheet because of, e.g., high core density or the application of a glue at the inner face side of the facing sheets such that delamination of the cover sheets is not an issue.

The board can be prepared according to any suitable method, e.g., through the use of pressure to form a strong matrix of interlocking gypsum crystals in the board core. Without wishing to be bound to any particular theory, the use of pressure upon the mixture for forming the set gypsum core, e.g., through the use of rollers in a continuous process or a press machine using a mold in a batch process, allows the gypsum crystals forming in the mixture to form hydrogen bonds and/or Van der Waals forces between gypsum crystals. This allows for the formation of the set gypsum with good strength. Water, stucco, gypsum, and optionally dry additives and/or wet additives are added to the mixture. The mixture can be allowed to start the setting process in the form of a continuous ribbon or into molds of desired dimensions for the board.

For example, in some embodiments, the mixture for forming the set gypsum core is deposited onto a moving conveyor (e.g., over a continuous cover sheet). A set of rollers disposed on either side of the mixture can be used to apply pressure on a continuous ribbon of the mixture in the shape of a board preform that then sets and is cut to desired dimensions to form the final board. The rollers can be composed of any suitable material useful for applying pressure to the mixture, such as stainless steel. The rollers on the top of the mixture can rotate suitably to allow pressure to be applied onto the mixture in the form of a ribbon. The rollers under the mixture can press the ribbon into the designated thickness. The rollers can apply pressure for any suitable length of time, e.g., from 1 second to 10 seconds, such as from 1 second to 5 seconds. The rollers can have any suitable diameter, e.g., from 10 cm to 100 cm, such as from 20 cm to 60 cm. The rollers can rotate at any suitable number of revolutions per minute (rpm), for example, from 20 rpm to 60 rpm, such as from 30 rpm to 50 rpm. The amount of pressure applied by the rollers can be from 50 psi to 500 psi, e.g., from 100 psi to 500 psi, or from 100 psi to 300 psi. In some embodiments, the rollers operate at or near room temperature, e.g., at a temperature of from 17° C. to 35° C., such as from 17° C. to 22° C., 20° C. to 27° C., from 20° C. to 25° C., from 22° C. to 27° C., or from 22° C. to 25° C., 25° C. to 32° C., 25° C. to 35° C., etc.

In alternate embodiments, the use of a machine press can be used instead of the use of rollers to form a ribbon. After mixing, the mixture for forming the set gypsum core is delivered to a mold containing a top plate as known in the art. The machine press is used to apply pressure on the mixture in the mold. In this respect, the machine press can contain top and bottom platens as known in the art, which press the top plate of the mold into a designated depth. For example, the machine press can be a hydraulic or pneumatic device as understood in the art. The press can function at any desired temperature such as room temperature. In some embodiments, the press operates at or near room temperature, e.g., at a temperature of from 17° C. to 35° C., such as from 17° C. to 22° C., 20° C. to 27° C., from 20° C. to 25° C., from 22° C. to 27° C., or from 22° C. to 25° C., 25° C. to 32° C., 25° C. to 35° C., etc. The machine press can apply any suitable pressure for any suitable duration depending on plant conditions. For example, in some embodiments, the pressure can be from 50 psi to 500 psi (e.g., from 100 psi to 500 psi, or from 100 psi to 300 psi) such as for a time period of from 10 seconds to 60 seconds, e.g., from 10 seconds to 30 seconds. The board can dry over time at room temperature or the drying can be escalated through the use of drying technology using heating elements from any suitable source, e.g., electric or natural gas heat at a temperature of from 50° C. to 150° C., for a duration of, e.g., 10 minutes to 60 minutes, such as from 10 minutes to 30 minutes.

In some embodiments, a skim coat is excluded between the core and one or both of the face and back cover sheets, respectively. For example, as the board is prepared under pressure, the skim coat is surprisingly found to be unnecessary as the gypsum crystals from the set gypsum core and the cover sheet interact, especially as higher density. In some embodiments, the cover sheets can be applied with the aid of adhesive on an inner face of the cover sheets (facing the set gypsum core or the mixture for forming it), especially at lower board densities or when the cover sheet is applied after the board core sets.

Advantageously, gypsum board prepared in accordance with embodiments of the disclosure allow for green technology. Since less water is used than in conventional methods for making board, drying time and expense are reduced, resulting in the use of less energy and emissions. In embodiments, the calcium sulfate dihydrate is used to replace a portion of the calcium sulfate hemihydrate. This advantageously has been found to save energy needed for calcination to form stucco since less stucco is used in the mixture because of the presence of the additional use of the uncalcined gypsum. The board also exhibits high quality as it displays good strength as desired in the market.

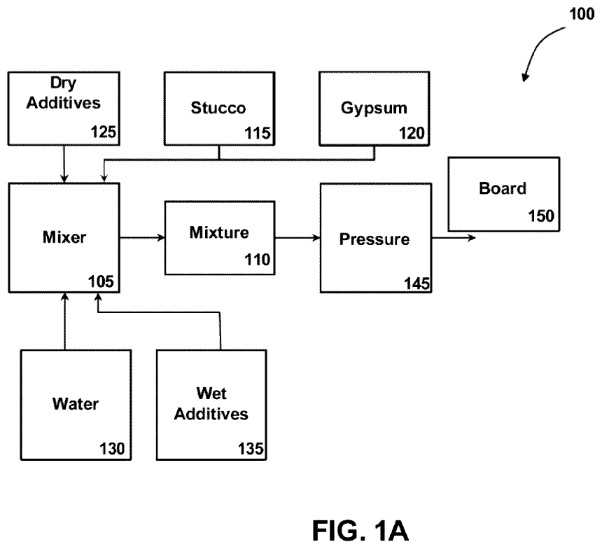

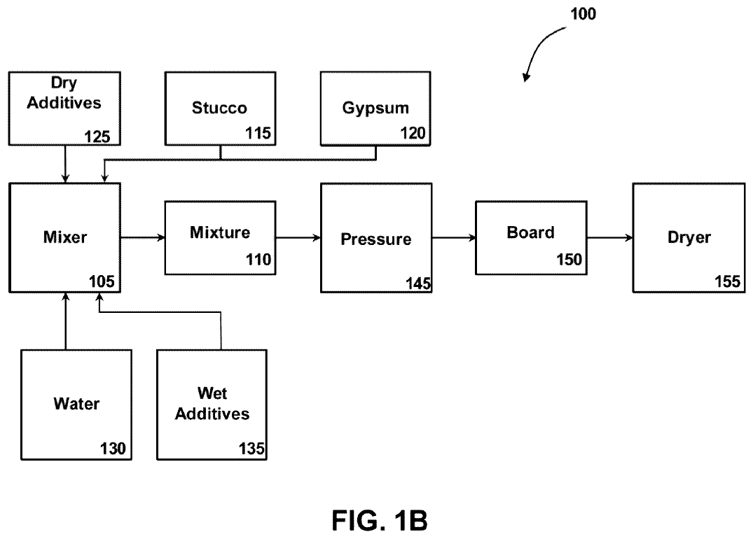

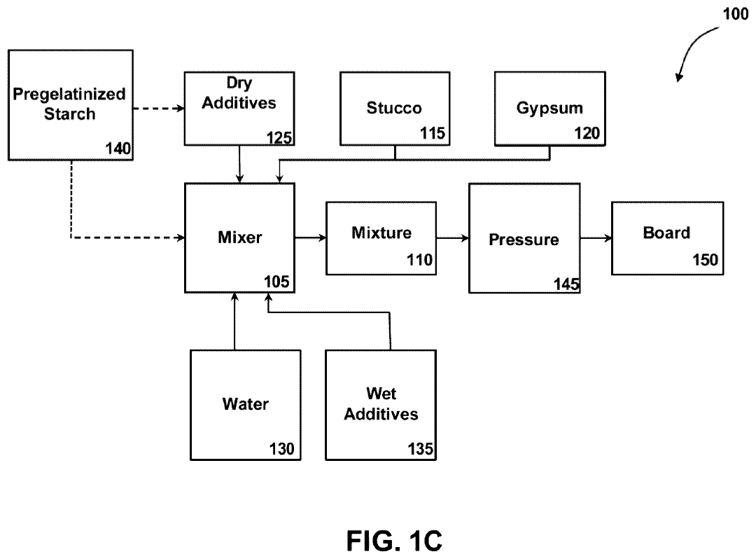

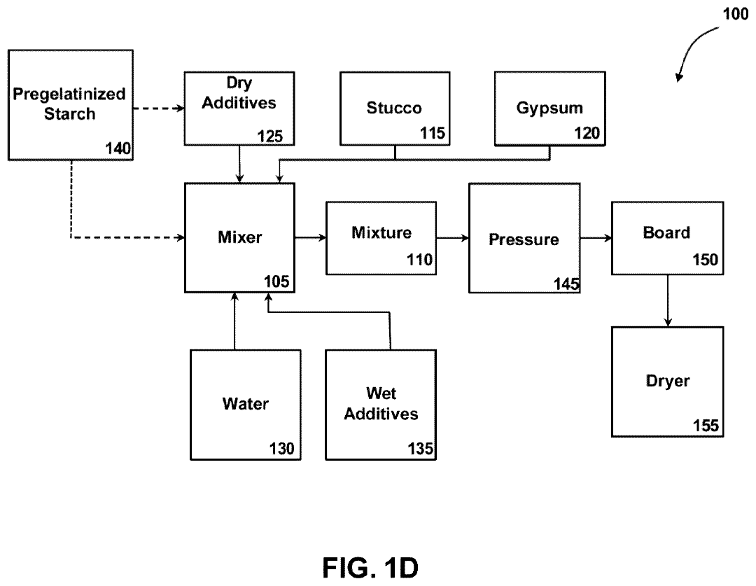

FIGS. 1A-1D are flow diagrams illustrating exemplary embodiments for board assembly systems 100. The systems 100 represented by the flow diagrams are suitable for use in embodiments of the principles of the present disclosure. A mixer 105 is used to form a mixture 110 for forming a set gypsum core. The mixer 105 can be a pin mixer as known in the art for forming conventional stucco mixture or a mixer suitable for mixing dry ingredients. In embodiments of the disclosure, the mixture 110 is in the form of a moistened powder and not a slurry. The moisture can be sprayed onto the mixed solid or included in the mixer as desired.

Stucco 115, gypsum 120, and, optionally, dry additives 125 are inserted into the mixer 105. Water 130 and wet additives 135 can be sprayed on the dry ingredients in the mixer 105 to form the mixture 110. Dry additives 130 can include, for example, polyphosphate, migrating starch, and lightweight filler (e.g., porous glass bead, perlite, wood cork, etc.) If desired, the stucco 120 and gypsum 125 can be delivered to the mixer 105 separately or combined first before insertion into the mixer 105. In some embodiments, pregelatinized starch 140 is added to the mixer 105, as shown in FIGS. 1C and 1D. The pregelatinized starch can be included in the dry additives 130 mix or delivered on its own into the mixer 105.

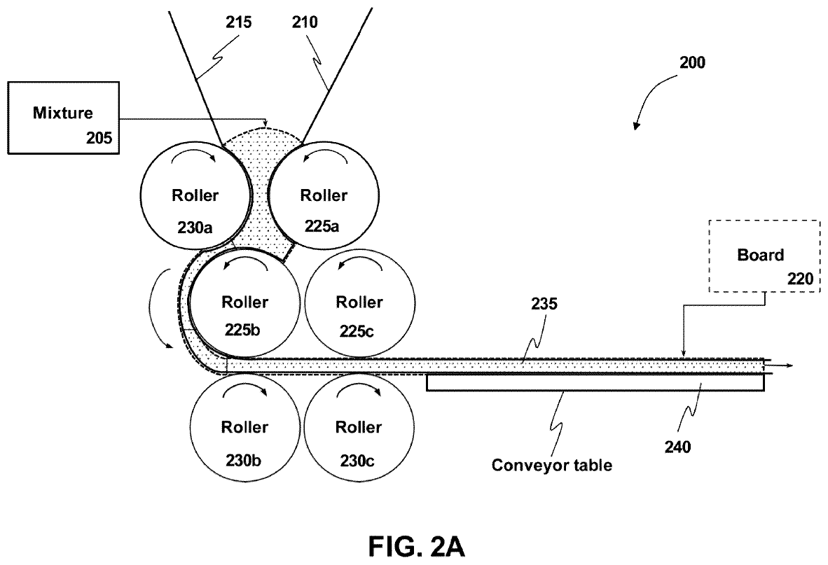

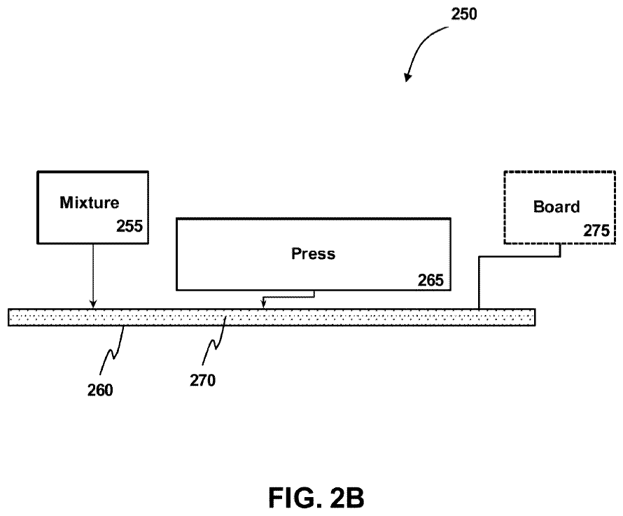

Pressure 145 is applied to the mixture 110 to form the board 150 at desired thickness, e.g., using roller technology as shown in FIG. 2A or press technology as shown in FIG. 2B. The mixture 110 at least partially sets under the pressure 145. A dryer apparatus 155 that is equipped with heating element(s) (e.g., electric or natural gas types) can optionally be used to dry the board 150, as seen in FIGS. 1B and 1D. The dryer apparatus 155 can function at any suitable temperatures, e.g., at temperatures of from 50° C. to 150° C., such as from 65° C. to 150° C., 65° C. to 120° C., from 800° C. to 120° C., from 100° C. to 120° C., etc. The dryer apparatus 155 can function for any suitable time, e.g., from 5 minutes to 120 minutes, such as from 10 minutes to 90 minutes, from 10 minutes to 60 minutes, from 10 minutes to 30 minutes, from 10 minutes to 20 minutes, from 5 minutes to 30 minutes, from 5 minutes to 20 minutes, from 5 minutes to 10 minutes, etc.

FIG. 2A schematically depicts an exemplary arrangement for the operation of a roller system 200 for creating pressure upon mixture 205 after exiting the mixer. A mixture 205 is prepared using ingredients and a mixer as described herein. The mixture 205 is deposited onto a groove between two cover sheets 210 and 215. In some embodiments the paper 210, which faces up as the rollers are applied can function as face paper in the final board product 220, while the paper 215, facing down, can function as the back paper in the final board product 220. The face side of the board faces out when installed while the back side of the board faces the supporting structure, e.g., studs, to which they are affixed. One or more top rollers (three shown as 225a, 225b, and 225c) can function on a top side of the mixture, while one or more bottom rollers (three shown as 230a, 230b, and 230c) can function on the bottom side of the mixture. The axes of the rollers can be supported by a stand. A board core 235 is formed under pressure in a sandwich structure between the cover sheets 210 and 215. A table 240 supports the system 200.

As an alternative, FIG. 2B schematically depicts an exemplary arrangement for the operation of a press system 250 for creating pressure upon mixture 255 after exiting the mixer. The mixture 255 is placed into a mold 260. A machine press 265 applies pressure (e.g., hydraulically or pneumatically) to form a board core 270 in the mold 260. The machine press 265 can operate at or near room temperature, e.g., from 20° C. to 30° C., or as described herein. The machine press 265 can operate for any suitable length of time, e.g., from 10 seconds to 120 seconds, such as from 10 seconds to 90 seconds, from 10 seconds to 60 seconds, from 10 seconds to 30 seconds, from 10 seconds to 20 seconds, etc., to form the board 275. The mold 260 can be sized to accommodate any desired board dimensions, e.g., for board having thickness of 3 to 13 mm (e.g., as typically in Europe) or 6 mm to 25.4 mm (e.g., as typically in the U.S.); a width of 60 cm to 125 cm (e.g., 120 cm as is typically found in Europe or 122 cm as typically found in the U.S); and a length of 100 cm to 500 cm (e.g., 240 cm as is typically found in Europe or 243 cm as is typically found in the U.S.). To illustrate, in some embodiments, the board can be made at a thickness of 12.7 mm, a width of 122 cm and a length or 122 cm or 243 cm. In some embodiments, the thickness of wallboard used for ceilings are usually 9.5 mm to 12.5 mm, while for walls they can be 12.5 mm to 15 mm, while the width can be 1200 mm and the length can be 3000 mm to 3600 mm. Cover sheets can be applied onto the face and/or back surfaces of the core 270 either inside the mold 260 or after the board 275 is formed, e.g., with the aid of adhesive.

In embodiments of the disclosure, the mixture for forming the set gypsum core contains both stucco and gypsum. The mixture sets due to the hydration reaction of the stucco to form gypsum. The gypsum is included in the mixture along with the stucco because it acts to fill the space between setting gypsum crystals. The gypsum can be sourced from natural rock or synthetic gypsum as known in the art. The mixture can have any suitable weight ratio of stucco to gypsum. For example, in some embodiments of the present disclosure, the mixture for forming the set gypsum core has a weight ratio of stucco to gypsum of from 9:1 to 40:1, such as from 15:1 to 20:1 and as further described herein, e.g., when pregelatinized starch is excluded. In some embodiments, e.g., where pregelatinized starch is included, the mixture can have a weight ratio of stucco to gypsum of from 1:1 to 40:1, such as from 2.5:1 to 40:1, 5:1 to 30:1, 10:1 to 25:1 and as further described herein.

In embodiments, the mixture can comprise pregelatinized starch to enhance board strength. Pregelatinized starch selected over uncooked starch in accordance with embodiments of the disclosure because the process may not be able to fully gelatinize the starch and penetrate starch molecules into the set gypsum matrix. Surprisingly and unexpectedly, the presence of pregelatinized starch allows for the inclusion of less stucco in the mixture because the pregelatinized starch functions to improve strength. The use of less stucco is desired in accordance with some embodiments because it can reduce the energy for calcination. In some embodiments, the mixture excludes uncooked strength-enhancing starch. In this respect, due to the low water content in the mixture, uncooked starch might not be completely cooked through the process.

Any suitable pregelatinized starch can be included in the mixture for forming the set gypsum core. If included, the pregelatinized starch can exhibit any suitable viscosity. In some embodiments, the pregelatinized starch is a mid-range viscosity starch as measured according to the VMA method as known in the art and as set forth in U.S. Pat. No. 10,399,899, which VMA method is hereby incorporated by reference. In other embodiments, the pregelatinized starch has a greater viscosity, such as greater than 700 centipoise (e.g., 773 centipoise) according to the VMA test.

In some embodiments, the pregelatinized starch is included in the mixture for forming the set gypsum core in an amount of 1% to 15% by weight of the solids, such as from 5% to 15% by weight of the solids, e.g., from 8% to 15% by weight of the solids, from 10% to 15% by weight of the solids, from 12% to 15% by weight of the solids, etc. It will be understood that the term “solids” in relation to “by weight of the solids” as used herein refers to the sum of the stucco and uncalcined gypsum unless otherwise indicated.

Suitable lightweight filler, such as cork, perlite, and/or porous glass beads, can be included in the mixture if desired to reduce density. The cork, expanded perlite, and glass beads can be in any suitable form and from any suitable source. For example, the cork can have an average diameter of, e.g., from 0.5 mm to 4 mm, such as from 1 mm to 2 mm. The cork can have a density of, e.g., from 3 pcf to 10 pcf, such as from 4 pcf to 5 pcf. The glass beads can have an average diameter of, e.g., from 3 mm to 8 mm, such as from 1 mm to 2 mm, and a density of, e.g., from 10 pcf to 20 pcf, such as from 10 pcf to 15 pcf. The expanded perlite can have an average particle size that passes through a 100 mesh screen, and a density of, e.g., from 2 pcf to 10 pcf, such as from 2 pcf to 6 pcf.

In some embodiments, the lightweight filler is present in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc. The use of such lightweight filler surprisingly and unexpectedly can allow for higher strength as board weight is reduced as compared with the use of air voids from the use of foaming agent as it has been found that light weight fillers provide more strength than air bubbles.

In embodiments, the mixture optionally comprises polyphosphate such as in the form of trimetaphosphate compounds. Suitable trimetaphosphate compounds include, for example, sodium trimetaphosphate, potassium trimetaphosphate, lithium trimetaphosphate, and ammonium trimetaphosphate. In some embodiments, the polyphosphate is in an amount of 0.01% to 0.2% by weight of the solids, such as from 0.05% to 0.2% by weight of the solids, e.g., from 0.1% to 0.2% by weight of the solids, etc.

In embodiments, the mixture for forming the set gypsum core optionally comprises retarder. In some embodiments, the retarder is pentasodium salt of diethylenetriaminepentaacetic acid (e.g., Versenex 80, commercially available from Dow Chemical Company, Midland, MI). The retarder can be added in the form of a wet additive, e.g., as a 1% solution in water. In some embodiments, the retarder is in an amount of 0.01% to 0.2% by weight of the solids, such as from 0.04% to 0.2% by weight of the solids, e.g., from 0.08% to 0.2% by weight of the solids, from 0.1% to 0.2% by weight of the solids, etc.

In some embodiments, the mixture for forming the set gypsum core excludes an accelerator, such as a heat-resistant accelerator (HRA) since it is surprisingly and unexpectedly unneeded because of the fast setting rate of the mixture formulation (e.g., when the uncalcined gypsum is present in an amount of 30% or less by weight of the total solids, e.g., from 5% to 30% by weight of the solids in the mixture for forming the set gypsum core), such as from 5% to 25%, from 5% to 20%, from 5% to 15%, from 10% to 30%, from 10% to 20%, from 15% to 30%, from 20% to 30%, etc.

In some embodiments, the mixture for forming the set gypsum core can include an accelerator (e.g., HRA). The HRA can be in the form of ground landplaster coated with dextrose, as known in the art. The accelerator (e.g., HRA) can be included in the mixture for forming the set gypsum core in any suitable amount, e.g., at least 0.2% by weight of the solids, etc. For example, in some embodiments, the accelerator (e.g., HRA) can be included in the mixture in an amount from 0.2% to 2% by weight of the solids, such as from 0.2% to 1.5%, from 0.2% to 1%, from 0.2% to 0.5%, from 0.5% to 2%, from 0.5% to 1.5%, from 0.5% to 1%, from 0.7% to 2%, from 0.7% to 1.5%, from 1% to 2%, from 1% to 1.5%, etc. Surprisingly and unexpectedly, it has been found that the presence of the HRA advantageously enhances more complete hydration to convert more stucco into gypsum needles even in the presence of uncalcined gypsum. Surprisingly and unexpectedly, the HRA thereby enhances strength in the board in accordance with some embodiments. For example, in some embodiments, the HRA is present when the uncalcined gypsum is included in an amount of at least 30% of the solids, e.g., from 30% to 50%, such as 30% to 50%, 30% to 40%, 40% to 50%, or 40% to 50%, etc. The presence of HRA can facilitate the use of higher percentages of uncalcined gypsum in the total solids content in the mixture for forming the set gypsum core, thereby reducing the energy used to calcine gypsum, thereby enhancing manufacturing efficiencies and allowing for green board prepared with lower energy consumption.

The mixture for forming the set gypsum core can have any suitable ratio of water to solids. For example, in accordance with embodiments of the present disclosure, the mixture can have a water/solids ratio of 0.3 or less (such as from 0.19 to 0.3, e.g., from 0.19 to 0.3, or 0.19 to 0.25, e.g., from 0.2 to 0.3, from 0.2 to 0.23, from 0.25 to 0.3, etc.). In embodiments of the disclosure, the mixture is thus a moistened solid as opposed to a slurry such that air foam voids are not introduced. In embodiments, the amount of water is selected to be the same or slightly higher than the amount of water stoichiometrically needed for the hydration reaction of the stucco to form gypsum (e.g., from 0% to 30% higher, such as from 0% to 20% higher or 10% to 25%, or 10 to 20% higher). It has been found that using slightly higher amounts of water than the stoichiometric amount needed for hydration is advantageous to allow for more complete hydration, resulting in better strength. As a practical matter, in operation, the use of the stoichiometric amount of water can sometimes result in incomplete hydration with some concomitant reduction in strength.

Board can be made with different dimensions, depending on, e.g., product type and market. The board can have any suitable width (e.g., 48 inches to 54 inches), length (e.g., 96 inches to 192 inches), and thickness (e.g., ¼ inch, ⅜ inch, ½ inch, ⅝ inch, ¾ inch, 1 inch, etc.). Dimensions in different markets may vary slightly as well understood in the art. It will be understood that the term “wallboard” can be used to relation to board for use in applications such as ceilings, walls, partitions, etc., as understood in the art. The board thickness can vary depending on the type of application for the product (e.g., regular board at ½ inch or fire-resistant board at ⅝ inch, i.e., 0.625 inch).

Board weight is a function of thickness. Since boards are commonly made at varying thickness, board density is used herein as a measure of board weight. The advantages of the use of the board in accordance with embodiments of the disclosure can be seen across various board densities, e.g., 40 pcf or less, such as from 10 pcf to 40 pcf, from 12 pcf to 40 pcf, from 16 pcf to 35 pcf, from 20 pcf to 40 pcf, from 24 pcf to 37 pcf, etc. For example, in some embodiments, board density can be, e.g. from 12 pcf to 35 pcf, from 12 pcf to 30 pcf, from 12 pcf to 27 pcf, from 16 pcf to 30 pcf, from 16 pcf to 27 pcf, from 16 pcf to 24 pcf, from 18 pcf to 30 pcf, from 18 pcf to 27 pcf, from 20 pcf to 30 pcf, from 20 pcf to 27 pcf, from 24 pcf to 35 pcf, from 27 pcf to 35 pcf, from 27 pcf to 34 pcf, from 27 pcf to 30 pcf, from 30 pcf to 34 pcf, etc. In some embodiments, the board can be prepared at much higher densities, e.g., from 35 pcf to 85 pcf, e.g., from 40 pcf to 85 pcf, from 45 pcf to 85 pcf, from 50 pcf to 85 pcf, from 55 pcf to 85 pcf, from 60 pcf to 85 pcf, from 65 pcf to 85 pcf, from 70 pcf to 85 pcf, from 75 pcf to 85 pcf, from 80 pcf to 85 pcf, etc.

Board prepared as described herein exhibit good strength. For example, in some embodiments, board according to the disclosure meets test protocols according to ASTM Standard C473-10, method B. In this regard, in some embodiments, when the board is cast at a thickness of ½ inch, the board has a nail pull resistance of at least 65 lb. as determined according to ASTM C 473-10, method B (e.g., at least 68 lb., at least 70 lb., at least 72 lb., at least 75 lb., at least 77 lb., in each case with any suitable upper limit, such as 110 lb. or greater, etc.). In accordance with some embodiments of the present disclosure, the board has a nail pull resistance according to ASTM 473-10 of from 75 pounds to 250 pounds, from 90 pounds to 250 pounds, from 100 pounds to 250 pounds, from 125 pounds to 250 pounds, from 150 pounds to 250 pounds, from 175 pounds to 250 pounds, from 200 pounds to 250 pounds, from 225 pounds to 250 pounds, etc.

With respect to flexural strength, in some embodiments, when cast in a board of ½ inch thickness, the board has a flexural strength of at least 36 lb. in a machine direction (e.g., at least 38 lb., at least 40 lb., etc., in each case with any suitable upper limit, such as 80 lb. or greater, etc.) and/or at least 107 lb. (e.g., at least 110 lb., at least 112 lb., etc., in each case with any suitable upper limit, such as 140 lb. or greater, etc.) in a cross-machine direction as determined according to the ASTM standard C473.

The disclosure is further illustrated by the following exemplary aspects. However, the disclosure is not limited by the following aspects.
(1) A board comprising a set gypsum core formed from a mixture comprising water, stucco, and gypsum. The mixture has a weight ratio of stucco to gypsum of from 9:1 to 40:1, such as from 15:1 to 20:1 (e.g., when pregelatinized starch is excluded). The mixture has a water/solids ratio of 0.4 or less (such as from 0.19 to 0.4, e.g., from 0.19 to 0.3, or 0.19 to 0.25, e.g., from 0.2 to 0.4, from 0.2 to 0.23, from 0.25 to 0.4, from 0.3 to 0.4, from 0.35 to 0.4, etc.).
(2) A board comprising a set gypsum core formed from a mixture comprising water, stucco, gypsum, and pregelatinized starch. The mixture has a weight ratio of stucco to gypsum of from 1:1 to 40:1, such as from 5:1 to 30:1, e.g., from 20:1 to 25:1. The mixture has a water/solids ratio of 0.3 or less (such as from 0.19 to 0.3, e.g., or 0.19 to 0.25, such as from 0.2 to 0.3, from 0.2 to 0.23, from 0.25 to 0.3 etc.).
(3) The board of aspects 1 or 2, wherein the mixture has a water/solids ratio of 0.3 or less, such as from 0.19 to 0.3, e.g., from 0.2 to 0.25, 0.19 to 0.25, or 0.20 to 0.24.
(4) The board of any one of aspects 1-3, wherein the mixture excludes an accelerator such as HRA (e.g., when the uncalcined gypsum is present in an amount of 30% or less by weight of the total solids, e.g., from 5% to 30% by weight of the solids, such as from 5% to 30%, 5% to 25%, 5% to 20%, 5% to 15%, 5% to 10%, 10% to 30%, 10% to 20%, 10% to 15%, 15% to 30%, 15% to 25%, 15% to 20%, 20% to 30%, 20% to 25%, or 25% to 30%, etc., in the mixture for forming the set gypsum core).
(5) The board of any one of aspects of claims 1-3, wherein the mixture contains accelerator such as HRA (e.g., when the uncalcined gypsum is present in an amount of 30% or more by weight of the total solids, e.g., from 30% to 50% by weight of the solids, such as 30% to 50%, 30% to 40%, 40% to 50%, or 40% to 50%, etc., in the mixture for forming the set gypsum core), wherein the HRA can be included in the mixture in an amount from 0.2% to 2% by weight of the solids, such as from 0.2% to 1.5%, from 0.2% to 1%, from 0.2% to 0.5%, from 0.5% to 2%, from 0.5% to 1.5%, from 0.5% to 1%, from 0.7% to 2%, from 0.7% to 1.5%, from 1% to 2%, from 1% to 1.5%, etc.
(6) The board of any one of aspects 1-5, wherein the mixture excludes foaming agent.
(7) The board of any one of aspects 1 and 3-6, wherein the mixture further comprises pregelatinized starch.
(8) The board of any one of aspects 2-7, wherein the pregelatinized starch is in an amount of 1% to 15% by weight of the solids, such as from 5% to 15% by weight of the solids, e.g., from 8% to 15% by weight of the solids, from 10% to 15% by weight of the solids, from 12% to 15% by weight of the solids, etc.
(9) The board of any one of aspects 1-8, wherein the mixture further comprises lightweight filler.
(10) The board of aspect 9, wherein the lightweight filler comprises cork in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc.
(11) The board of aspects 9 or 10, wherein the lightweight filler comprises porous glass beads in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc.
(12) The board of any one of aspects 9-11, wherein the lightweight filler comprises expanded perlite in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc.
(13) The board of any one of aspects 1-12, wherein the board includes at least one cover sheet and the board excludes a skim coat between the board core and the cover sheet.
(14) The board of any one of aspects 1-13, wherein the mixture further comprises polyphosphate in an amount of 0.01% to 0.2% by weight of the solids, such as from 0.05% to 0.2% by weight of the solids, e.g., from 0.1% to 0.2% by weight of the solids, etc.
(15) The board of any one of aspects 1-14, wherein the mixture further comprises retarder.
(16) The board of aspect 15, wherein the retarder is pentasodium salt of diethylenetriaminepentaacetic acid.
(17) The board of aspects 15 or 16, wherein the retarder is in an amount of 0.01% to 0.2% by weight of the solids, such as from 0.04% to 0.2% by weight of the solids, e.g., from 0.08% to 0.2% by weight of the solids, from 0.1% to 0.2% by weight of the solids, etc.
(18) The board of any one of aspects 1-17, wherein the board has a density of 15 pcf to 85 pcf, such as from 20 pcf to 70 pcf, e.g., from 20 pcf to 60 pcf, from 20 pcf to 50 pcf, from 20 pcf to 40 pcf, from 20 pcf to 35 pcf, from 20 pcf to 30 pcf, from 30 pcf to 85 pcf, from 30 pcf to 70 pcf, from 30 pcf to 60 pcf, from 30 pcf to 50 pcf, from 30 pcf to 40 pcf, from 40 pcf to 85 pcf, from 40 pcf to 70 pcf, from 40 pcf to 60 pcf, from 40 pcf to 50, from 50 pcf to 85 pcf, from 50 pcf to 70 pcf, from 50 pcf to 60 pcf, from 60 pcf to 85 pcf, from 70 pcf to 85 pcf, etc.
(19) The board of any one of aspects 1-18, wherein the board has a nail pull resistance of at least 75 pounds according to ASTM 473-10, such as from 75 pounds to 250 pounds, from 90 pounds to 250 pounds, from 100 pounds to 250 pounds, from 125 pounds to 250 pounds, from 150 pounds to 250 pounds, from 175 pounds to 250 pounds, from 200 pounds to 250 pounds, from 225 pounds to 250 pounds, etc.
(20) A method of making board comprising a set gypsum core, the method comprising: mixing ingredients comprising water, stucco, and gypsum to form a mixture having a weight ratio of stucco to gypsum of from 9:1 to 40:1, such as from 15:1 to 40:1, e.g., from 25:1 to 40:1 and as further described herein (e.g., when pregelatinized starch is excluded), and the mixture having a water/solids ratio of 0.3 or less (such as from 0.19 to 0.3, e.g., from 0.19 to 0.3, or 0.19 to 0.25, e.g., from 0.2 to 0.3, from 0.2 to 0.23, from 0.25 to 0.43, etc.); pressing the mixture; and drying the mixture.
(21) A method of making board comprising a set gypsum core, the method comprising: mixing ingredients comprising water, stucco, gypsum, and pregelatinized starch to form a mixture having a weight ratio of stucco to gypsum of from 1:1 to 40:1, such as from 2.5:1 to 40:1, 5:1 to 40:1, from 20:1 to 40:1, and as further described herein etc., and the mixture having a water/solids ratio of 0.3 or less (such as from 0.19 to 0.3, e.g., or 0.19 to 0.25, e.g., from 0.2 to 0.3, from 0.2 to 0.23, from 0.25 to 0.3, etc.); pressing the mixture; and drying the mixture.
(22) The method of aspects 20 or 21, wherein the mixture has a water/solids ratio of 0.3 or less, such as from 0.19 to 0.3, e.g., from 0.2 to 0.25, from 0.20 to 0.24, or from 0.19 to 0.25, etc.
(23) The method of any one of aspects 20-22, wherein the mixture excludes foaming agent.
(24) The method of any one of aspects 20-23, wherein the mixture excludes accelerator such as HRA (e.g., when the uncalcined gypsum is present in an amount of 30% or less by weight of the total solids, e.g., from 5% to 30% by weight of the solids, such as from 5% to 30%, 5% to 25%, 5% to 20%, 5% to 15%, 5% to 10%, 10% to 30%, 10% to 20%, 10% to 15%, 15% to 30%, 15% to 25%, 15% to 20%, 20% to 30%, 20% to 25%, or 25% to 30%, etc., in the mixture for forming the set gypsum core).
(25) The method of any one of aspects 20-23, wherein the mixture contains accelerator such as HRA (e.g., when the uncalcined gypsum is present in an amount of 30% or more by weight of the total solids, e.g., from 30% to 50% by weight of the solids, such as 30% to 50%, 30% to 40%, 40% to 50%, or 40% to 50%, etc., in the mixture for forming the set gypsum core), wherein the HRA can be included in the mixture in an amount from 0.2% to 2% by weight of the solids, such as from 0.2% to 1.5%, from 0.2% to 1%, from 0.2% to 0.5%, from 0.5% to 2%, from 0.5% to 1.5%, from 0.5% to 1%, from 0.7% to 2%, from 0.7% to 1.5%, from 1% to 2%, from 1% to 1.5%, etc.
(26) The method of any one of aspects 20 and 22-25, wherein the mixture further comprises pregelatinized starch.
(27) The method of any one of aspect 21-26, wherein the pregelatinized starch is in an amount of 1% to 15% by weight of the solids, such as from 5% to 15% by weight of the solids, e.g., from 8% to 15% by weight of the solids, from 10% to 15% by weight of the solids, from 12% to 15% by weight of the solids, etc.
(28) The method of any one of aspects 19-27, wherein the mixture further comprises lightweight filler.
(29) The method of aspect 28, wherein the lightweight filler comprises cork in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc.
(30) The method of aspects 28 or 29, wherein the lightweight filler comprises porous glass beads in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc.
(31) The method of any one of aspects 28-30, wherein the lightweight filler comprises expanded perlite in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc.
(32) The method of any one of aspects 20-31, wherein at least one cover sheet is applied to at least one side of the core (e.g., optionally using adhesive), and the board excludes a skim coat between the board core and the cover sheet.
(33) The method of any one of aspects 20-32, wherein the mixture further comprises polyphosphate in an amount of 1% to 15% by weight of the solids, such as from 5% to 15% by weight of the solids, e.g., from 8% to 15% by weight of the solids, from 10% to 15% by weight of the solids, from 12% to 15% by weight of the solids, etc.
(34) The method of any one of aspects 20-33 wherein the mixture further comprises retarder.
(35) The method of aspect 34, wherein the retarder is pentasodium salt of diethylenetriaminepentaacetic acid.
(36) The method of aspects 34 or 35, wherein the retarder is in an amount of 0.01% to 0.2% by weight of the solids, such as from 0.04% to 0.2% by weight of the solids, e.g., from 0.08% to 0.2% by weight of the solids, from 0.1% to 0.2% by weight of the solids, etc.
(37) The method of any one of aspects 20-36, wherein the board has a density of 15 pcf to 85 pcf, such as from 20 pcf to 70 pcf, e.g., from 20 pcf to 60 pcf, from 20 pcf to 50 pcf, from 20 pcf to 40 pcf, from 20 pcf to 35 pcf, from 20 pcf to 30 pcf, from 30 pcf to 85 pcf, from 30 pcf to 70 pcf, from 30 pcf to 60 pcf, from 30 pcf to 50 pcf, from 30 pcf to 40 pcf, from 40 pcf to 85 pcf, from 40 pcf to 70 pcf, from 40 pcf to 60 pcf, from 40 pcf to 50, from 50 pcf to 85 pcf, from 50 pcf to 70 pcf, from 50 pcf to 60 pcf, from 60 pcf to 85 pcf, from 70 pcf to 85 pcf, etc.
(38) The method of any one of aspects 20-37, wherein the board has a nail pull resistance of at least 75 pounds according to ASTM 473-10, such as from 75 pounds to 250 pounds, from 90 pounds to 250 pounds, from 100 pounds to 250 pounds, from 125 pounds to 250 pounds, from 150 pounds to 250 pounds, from 175 pounds to 250 pounds, from 200 pounds to 250 pounds, from 225 pounds to 250 pounds, etc.
(39) The method of any one of aspects 20-38, wherein the pressing is hydraulically or pneumatically applied using a machine press.
(40) The method of any one of aspects 20-38, wherein the pressing is applied using one or more sets (top and bottom pairings) of rollers.
(41) The method of any one of aspects 20-40, wherein the pressing is applied at a pressure of from 50 psi to 500 psi.
(42) The method of any one of aspects 20-41, wherein the pressure is applied for from 10 to 60 seconds.
(43) A mixture comprising water, stucco, gypsum, and lightweight filler, the mixture having a weight ratio of stucco to gypsum of from 1:1 to 40:1, such as from 3:1 to 10:1, e.g., from 3.5:1 to 5:1 and as further described herein; and the mixture having a water/solids ratio of 0.3 or less (such as from 0.19 to 0.3, e.g., from 0.19 to 0.3, or 0.19 to 0.25, e.g., from 0.2 to 0.3, from 0.2 to 0.23, from 0.25 to 0.3, etc.).
(44) A mixture comprising water, stucco, gypsum, lightweight filler, and pregelatinized starch; the mixture having a weight ratio of stucco to gypsum of from 1:1 to 40:1, such as from 10:1 to 30:1, e.g., from 20:1 to 25:1 and as further described herein; and the mixture having a water/solids ratio of 0.3 or less (such as from 0.19 to 0.3, e.g., from 0.19 to 0.3, or 0.19 to 0.25, e.g., from 0.2 to 0.3, from 0.2 to 0.23, from 0.25 to 0.3, etc.).
(45) The mixture of aspects 43 or 44, wherein the lightweight filler comprises porous beads, perlite, and/or cork.
(46) The mixture of any one of aspects 43-45, wherein the lightweight filler comprises cork in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc.
(47) The mixture of any one of aspects 43-46, wherein the lightweight filler comprises porous glass beads in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc.
(48) The mixture of any one of aspects 43-47, wherein the lightweight filler comprises expanded perlite in an amount of 1% to 30% by weight of the solids, such as from 5% to 30% by weight of the solids, e.g., from 10% to 30% by weight of the solids, from 15% to 30% by weight of the solids, from 20% to 30% by weight of the solids, from 25% to 30% by weight of the solids, etc.
(49) The mixture of any one of aspects 43-48, wherein the mixture has a water/solids ratio of from 0.3 or less, such as from 0.19 to 0.3, e.g., from 0.2 to 0.25, or from 0.19 to 0.24, etc.
(50) The mixture of any one of aspects 43 and 45-49, wherein the mixture further comprises pregelatinized starch.
(51) The mixture of any one of aspects 43-50, wherein the pregelatinized starch is in an amount of 1% to 15% by weight of the solids, such as from 5% to 15% by weight of the solids, e.g., from 8% to 15% by weight of the solids, from 10% to 15% by weight of the solids, from 12% to 15% by weight of the solids, etc.
(52) The mixture of any one of aspects 43-51, wherein the mixture further comprises polyphosphate in an amount of 0.01% to 0.2% by weight of the solids, such as from 0.05% to 0.2% by weight of the solids, e.g., from 0.1% to 0.2% by weight of the solids, etc.
(53) The mixture of any one of aspects 43-52, wherein the mixture further comprises retarder.
(54) The mixture of aspect 53, wherein the retarder is pentasodium salt of diethylenetriaminepentaacetic acid.
(55) The mixture of aspects 53 or 54, wherein the retarder is in an amount of 0.01% to 0.2% by weight of the solids, such as from 0.04% to 0.2% by weight of the solids, e.g., from 0.08% to 0.2% by weight of the solids, from 0.1% to 0.2% by weight of the solids, etc.
(56) The mixture of any one of aspects 43-55, wherein the mixture excludes foaming agent.
(57) The mixture of any one of aspects 43-56, wherein the mixture excludes an accelerator such as HRA (e.g., when the uncalcined gypsum is present in an amount of 30% or less by weight of the total solids, e.g., from 5% to 30% by weight of the solids, such as from 5% to 30%, 5% to 25%, 5% to 20%, 5% to 15%, 5% to 10%, 10% to 30%, 10% to 20%, 10% to 15%, 15% to 30%, 15% to 25%, 15% to 20%, 20% to 30%, 20% to 25%, or 25% to 30%, etc., in the mixture for forming the set gypsum core).
(58) The mixture of any one of aspects of claims 43-56, wherein the mixture contains accelerator such as HRA (e.g., when the uncalcined gypsum is present in an amount of 30% or more by weight of the total solids, e.g., from 30% to 50% by weight of the solids, such as 30% to 50%, 30% to 40%, 40% to 50%, or 40% to 50%, etc., in the mixture for forming the set gypsum core), wherein the HRA can be included in the mixture in an amount from 0.2% to 2% by weight of the solids, such as from 0.2% to 1.5%, from 0.2% to 1%, from 0.2% to 0.5%, from 0.5% to 2%, from 0.5% to 1.5%, from 0.5% to 1%, from 0.7% to 2%, from 0.7% to 1.5%, from 1% to 2%, from 1% to 1.5%, etc.
(59) The mixture of any one of aspects 43-58, wherein the mixture is cast into the form of a board having a density of from 15 pcf to 85 pcf, such as from 20 pcf to 70 pcf, e.g., from 20 pcf to 60 pcf, from 20 pcf to 50 pcf, from 20 pcf to 40 pcf, from 20 pcf to 35 pcf, from 20 pcf to 30 pcf, from 30 pcf to 85 pcf, from 30 pcf to 70 pcf, from 30 pcf to 60 pcf, from 30 pcf to 50 pcf, from 30 pcf to 40 pcf, from 40 pcf to 85 pcf, from 40 pcf to 70 pcf, from 40 pcf to 60 pcf, from 40 pcf to 50, from 50 pcf to 85 pcf, from 50 pcf to 70 pcf, from 50 pcf to 60 pcf, from 60 pcf to 85 pcf, from 70 pcf to 85 pcf, etc.
(60) The mixture of any one of aspects 43-59, wherein the mixture is cast into a board having a nail pull resistance of at least 75 pounds according to ASTM 473-10, such as from 75 pounds to 250 pounds, from 90 pounds to 250 pounds, from 100 pounds to 250 pounds, from 125 pounds to 250 pounds, from 150 pounds to 250 pounds, from 175 pounds to 250 pounds, from 200 pounds to 250 pounds, from 225 pounds to 250 pounds, etc.

It shall be noted that the preceding aspects are illustrative and not limiting. Other exemplary combinations are apparent from the entirety of the description herein. It will also be understood by one of ordinary skill in the art that various embodiments may be used in various combinations with the other embodiments provided herein.

The following examples further illustrate the disclosure but, of course, should not be construed as in any way limiting its scope.

### Example 1

This example demonstrates exemplary benefits of compositions according to principles of embodiments of the disclosure. To measure the impact on density and nail pull (“NP”) strength of boards prepared with the press, two formulations of gypsum board were produced and tested (Boards 1A and 1B). Boards 1A and 1B were made with the same mixture (same percentage of every ingredient). Board A was pressed with 500 g mixture and Board B was pressed with 400 g mixture.

The following process was performed to form Boards 1A and 1B. Stucco was placed into a bowl of a Hobart mixer. Water and retarder were sprayed on the stucco while mixing. The respective mixtures were transferred into molds to make Boards 1A and 1B, respectively. The molds were 6″×6″×0.5″. Once the mixture was placed into the mold, the mixture was then pressed at 15,000 lb. for 60 seconds at room temperature using a hot press (model 3895, commercially available from Carver, Inc., Wabash, IN). Board 1A had good paper-core bonding. Regular wallboard paper face was then glued on both sides of the board 1B. The samples were dried at 110° F. overnight.

Table 1 depicts the formulations for Boards 1A and 1B. 500 g or 400 g of the mixture was used to make Boards 1A and 1B, respectively.

TABLE 1

Board 1A and 1B

| | Grams (g) | % (Stucco basis) |
|---|---|---|
| Stucco (calcined gypsum) | 500 | 100 |
| Water | 115 | 23 |
| Retarder | 0.23 | 0.046 |

Board 1A demonstrated a density of 106 pcf and a NP strength of 344 lb., while Board 1B demonstrated a density of 85 pcf and a NP strength of 155 lb. Surprisingly and unexpected, stucco was rehydrated at stoichiometric water, without extra water. By way of comparison, a conventional process typically uses more than three times of stoichiometric water to make board which requires the extra water to be dried off from the final products.

### Example 2

This example demonstrates exemplary benefits of compositions according to principles of embodiments of the disclosure. Specifically, this example demonstrates the properties of gypsum board prepared with 25% uncalcined gypsum at water to gypsum ratio of 0.20, wherein 25% of stucco was replaced by uncalcined gypsum.

To measure the impact on density and nail pull (“NP”) strength of boards prepared with the press, two formulations of gypsum board were produced and tested (Boards 2A and 2B). Boards 2A and 2B were produced following the same procedures as Boards 1A and 1B, respectively, except 420 g of the mixture was used to make the boards.

Table 2 depicts the formulations for Boards 2A and 2B.

TABLE 2

| | Board 2A | | Board 2B | |
|---|---|---|---|---|
| | | % (Total | | % (Total |
| | Grams (g) | Gypsum Basis) | Grams (g) | Gypsum Basis) |
| Stucco (calcined | 300 | 75 | 300 | 75 |
| gypsum) | | | | |
| Uncalcined | 100 | 25 | 100 | 25 |
| gypsum | | | | |
| Pregelatinized | | | 20 | 5 |
| starch | | | | |
| Water | 80 | 20 | 80 | 20 |
| Retarder | 0.16 | 0.04 | 0.16 | 0.04 |

Board 2A demonstrated a density of 85 pcf and a nail pull strength of 114 lb., which was about 40 lb. lower than the board made with pure stucco. However, when 5% of pregelatinized starch was added, the nail pull strength of Board 2B (233 lb.) was higher than the Board 1B made from pure stucco. This demonstrates that pregelatinized starch can allow for a reduction in board weight while still maintaining good strength in accordance with some embodiments of the disclosure.

### Example 3

This example demonstrates exemplary benefits of compositions according to principles of embodiments of the disclosure. Specifically, this example demonstrates the properties of gypsum board prepared using low density filler in accordance with embodiments of the present disclosure.

To measure the impact on density and NP strength of boards prepared with the press, three formulations of gypsum board were produced and tested (Boards 3A-3C). Boards 3A-3C were produced following the same procedures as Boards 1A and 1B, respectively, except 270 g of mixture was used to make the boards and the pressure of 83 psi was used. In addition, Board 3A included 25% of low-density porous glass bead filler. Boards 3B and 3C included 15% cork filler.

Table 3 depicts the formulations for Boards 3A-3C.

TABLE 3

| | Board 3A | | Board 3B | | Board 3C | |
|---|---|---|---|---|---|---|
| | | % (Stucco | | % (Stucco | | % (Stucco |
| | Grams (g) | basis) | Grams (g) | Basis) | Grams (g) | basis) |
| Stucco | 200 | 100 | 200 | 100 | 200 | 100 |
| Porous glass | 50 | 25 | N/A | N/A | N/A | N/A |
| bead | | | | | | |
| Cork (0.5-1 | N/A | N/A | 30 | 15 | 30 | 15 |
| mm) | | | | | | |
| Pregelatinized | 16 | 8 | 16 | 8 | 16 | 8 |
| starch | | | | | | |
| Water | 80 | 40 | 80 | 40 | 70 | 35 |
| Retarder | 0.16 | 0.08 | 0.16 | 0.04 | 0.16 | 0.04 |

Board 3A demonstrated a core density of 48 pcf and a nail pull strength of 111 lb. Boards 3B and 3C demonstrated a core density of 48 pcf had a nail pull strength of 75 lb. and 77 lb., respectively. This demonstrates that with the aid of pregelatinized starch, lightweight board can be produced with good strength in accordance with some embodiments of the disclosure.

### Example 4

This example demonstrates exemplary benefits of compositions according to principles of embodiments of the disclosure. Specifically, this example demonstrates the properties of gypsum board prepared with 50% uncalcined gypsum, 10% pregelatinized starch, and 0.5% of heat-resistant accelerator (HRA). The HRA was in the form of dextrose coated landplaster. More particularly, the HRA was made of ground gypsum and 5% dextrose coated thereon.

To measure the impact on nail-pull strength (“NP”) of gypsum boards, a formulation of gypsum board was produced using a press and tested (Board 4A). Board 4A was mixed following the same procedures as Boards 1A and 1B, except 420 g of the mixture was used to make the boards. Once the mixture was placed into the mold, the mixture was then pressed at 15,000 lb. for 3 minutes at room temperature using a hot press (model 3895, commercially available from Carver, Inc., Wabash, IN). The actual load on the gypsum materials was around 4000 lb. The samples were dried at 110° F. overnight.

Table 4 depicts the formulations for the mixture for preparing the set gypsum core for Board 4A. The mixture had a water/solids ratio of 0.2, where solids refers to the sum of stucco and uncalcined gypsum.

TABLE 4

Board 4A

| | Grams (g) | % (Stucco basis) |
|---|---|---|
| Stucco | 200 | 50 |
| Uncalcined gypsum | 200 | 50 |
| HRA | 2 | 0.5 |
| Pregelatinized starch | 40 | 10 |
| Water | 80 | 20 |
| Retarder | 0.16 | 0.04 |

Board 4A demonstrates that HRA enhances stucco hydration and facilitates improvement in strength. The board exhibited a core density of 85 pcf and a nail pull strength of 208 lb. This demonstrates that more uncalcined gypsum can be used to make boards. By using higher amounts of uncalcined gypsum (e.g., at least 50% by weight of the solids) in the mixture for forming the set gypsum core, energy usage and carbon emissions can be reduced during board production. As a result, surprisingly and unexpectedly, the board can be prepared in a more sustainable manner such that the board can be considered green.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Stucco and water are fundamental ingredients in a slurry and are thus not considered additives. When amounts are compared between the core and dense layer slurries, it will be understood that it is in relation to a relative comparison, i.e., concentration. To the extent that some portions of the description may refer to the primary and secondary discharge conduits as integral to the board mixer and other portions may refer to them as separate pieces, it will be understood that any such difference in description does not suggest or imply different arrangements unless otherwise indicated. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. All amounts are by weight and not by volume, unless otherwise indicated. Variations of those preferred embodiments can become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A board comprising a set gypsum core formed from a mixture comprising water, stucco, and gypsum;
the mixture having a weight ratio of stucco to gypsum of from 1:1 to 40:1; and
the mixture having a water/solids ratio of 0.3 or less.

2. The board of claim 1, the mixture further comprising pregelatinized starch.

3. The board of claim 1, the mixture excluding pregelatinized starch and the mixture having a weight ratio of stucco to gypsum of from 9:1 to 40:1.

4. The board of claim 1, wherein the mixture excludes an accelerator and the uncalcined gypsum is present in an amount of 30% or less by weight of the total solids in the mixture for forming the set gypsum core.

5. The board of claim 1, wherein the mixture contains accelerator, wherein the uncalcined gypsum is present in an amount of 30% or more by weight of the total solids, and wherein the accelerator is included in the mixture in an amount from 0.2% to 2% by weight of the solids.

6. The board of claim 1, wherein the mixture excludes foaming agent.

7. The board of claim 1, wherein the mixture further comprises lightweight filler comprising one or more of cork, porous glass, expanded perlite, or any combination thereof.

8. A method of making board comprising a set gypsum core, the method comprising:
mixing ingredients comprising water, stucco, and gypsum to form a mixture having a weight ratio of stucco to gypsum of from 1:1 to 40:1, and the mixture having a water/solids ratio of 0.3 or less;
pressing the mixture;
and drying the mixture.

9. The method of claim 9, the ingredients further comprising pregelatinized starch.

10. The method of claim 9, wherein the ingredients exclude pregelatinized starch and the mixture has a weight ratio of stucco to gypsum of from 9:1 to 40:1.

11. The method of claim 9, wherein the ingredients exclude foaming agent.

12. The method of claim 9, wherein the mixture excludes HRA and the uncalcined gypsum is present in an amount of 50% by weight of the total solids.

13. The method of claim 9, wherein the HRA and the uncalcined gypsum is present in an amount of 30% or more by weight of the total solids, and wherein HRA is included in the mixture in an amount from 0.2% to 2% by weight of the solids.

14. The method of claim 9, wherein the mixture further comprises lightweight filler.

15. The method of claim 9, wherein the pressing is hydraulically or pneumatically applied using a machine press.

16. The method of claim 9, wherein the pressing is applied using one or more sets of rollers comprising top and bottom pairings.

17. The method of claim 9, wherein the pressing is applied at a pressure of from 50 psi to 500 psi, and wherein the pressure is applied for from 10 to 60 seconds.

18. A mixture comprising water, stucco, gypsum, and lightweight filler;
the mixture having a weight ratio of stucco to gypsum of from 1:1 to 40:1; and
the mixture having a water/solids ratio of 0.3 or less.

19. The mixture of claim 18, the mixture further comprising pregelatinized starch.

20. The mixture of claim 18, wherein the mixture excludes pregelatinized starch and the weight ratio of stucco to gypsum is from 9:1 to 40:1.
